(19) United States
(12) Patent Application Publication
(10) Pub. No.: US 2013/0184952 A2
(43) Pub. Date: Jul. 18, 2013

(54) METHOD FOR SETTING CHARACTERISTIC VARIABLES OF A BRAKE SYSTEM IN A MOTOR VEHICLE

(71) Applicants: Thomas Lich, Schwaikheim (DE); Frank Ewerhart, Elhofen (DE); Reiner Marchthaler, Gingen (DE); Stephan Stabrey, Stuttgart (DE); Andreas Georgi, Schwieberdingen (DE)

(72) Inventors: Thomas Lich, Schwaikheim (DE); Frank Ewerhart, Elhofen (DE); Reiner Marchthaler, Gingen (DE); Stephan Stabrey, Stuttgart (DE); Andreas Georgi, Schwieberdingen (DE)

(73) Assignee: Robert Bosch GmbH, Stuttgart, DE (DE)

(21) Appl. No.: 12/308,341

(22) PCT Filed: Nov. 5, 2007
(86) PCT No.: PCT/EP2007/061872

§ 371 Date: Apr. 20, 2010

(30) Foreign Application Priority Data
Nov. 15, 2006 (DE) 10 2006 053 809.9

(51) Int. Cl. G06F 19/00

(52) U.S. Cl. 701/70

(57) ABSTRACT

In a method for setting characteristic variables of a brake system in a motor vehicle, driver type identification is performed first and the identified driver type is classified into an assigned driver type class. Brake system characteristic variables of this class of driver type are then activated.

### FIELD OF THE INVENTION

The present invention relates to a method for setting characteristic variables of a brake system in a motor vehicle.

### BACKGROUND INFORMATION

German patent document DE 43 25 940 C1 discusses a so-called brake assistant in a motor vehicle, including a hydraulically controlled brake system, in which the brake pressure is adjustable via electrically triggerable regulating valves. To shorten the stopping distance in critical driving situations, driver responses, in particular the operating speed of the brake pedal and the brake pedal pressure created by the driver are measured, and when predefined limiting values are exceeded, signals to increase the brake pressure are generated. By amplifying the brake pressure selected by the driver, it is possible to build up a maximum possible brake pressure, permitting a significant shortening of the stopping distance. Automatic amplification of the brake pressure makes it possible to fully utilize the theoretical potential of a brake system in the best possible way.

To be sure that the brake assistant is activated only in emergencies and to avoid faulty deployment during normal driving operation, the parameterization of the brake system is usually designed in such a way that the brake assistant is not deployed during normal driving. Detection of an emergency situation and a subsequently activated brake assistant occurs only when operation of the brake pedal is substantially above a value range assigned to a normal braking operation with regard to pedal speed and pressure buildup. However, this entails the risk that an emergency situation might not be detected correctly and the stopping distance might not be shortened in the best possible manner.

### SUMMARY OF THE INVENTION

An object of the exemplary embodiments and/or exemplary methods of the present invention is to optimize brake operation in a motor vehicle. Emergency situations should advantageously be detected reliably and appropriate measures taken to shorten the stopping distance.

This object is achieved according to the exemplary embodiments and/or exemplary methods of the present invention by the features described herein. Expedient further embodiments are also described herein.

In the method of the present invention for setting characteristic variables of a brake system in a motor vehicle, several different driver type classes are defined, a set of brake system characteristic variables being assigned to each class. By categorizing drivers and assigning them to discrete classes, a preselection and restriction of specific brake system parameters may be made. It is possible in this way, regardless of the prevailing driving situation, to select and activate brake system parameters that are adapted to the particular type of driver even before an emergency situation occurs and thereby improve the quality of the braking operation. The brake system parameters to be adapted include in particular setpoint threshold values which are definitive for the deployment and/or activation of a brake assistant to support the braking operation in emergencies, in particular threshold values for the pedal speed and pedal pressure. If necessary, adaptation of brake parameters which influence the braking operation per se, e.g., the measure of brake force amplification, may also be considered, if necessary.

In this method, first driver type identification is performed, and the identified type of driver is assigned to an existing driver type class in the brake system. In a second step, the brake system characteristic variables belonging to this driver type class are activated. In particular the brake pressure in the brake system and variables derived therefrom and/or associated therewith are taken into account as brake system characteristic variables, i.e., parameters.

In comparison with existing systems known from the related art in which the limiting values influencing driving dynamics are ascertained from current driver responses, providing discrete driver type classes has the advantage that additional driver-specific aspects that affect the driver's behavior may be taken into account. For example, it is possible to make a gender differentiation between male and female drivers to thereby take into account the fact that men usually operate the brake pedal using a higher force than women in emergency situations. Accordingly, a different set of brake system parameters may be activated, the result being that the deployment threshold for activation of the brake assistant in emergency situations is lowered and/or a higher additional brake pressure is generated in the case of a female driver in comparison with a male driver.

In principle, a number of different driver type classes may be provided. In addition to differentiating between male and female, an age categorization has proven advantageous to allow declining response times on the part of the driver with advancing age to be factored in. For example, if it is determined that the driver is elderly, the deployment threshold may be lowered in emergency situations and a more rapid pressure buildup may be implemented, if necessary, than in the case of a younger driver.

As further categorization, detection of the height of the driver and corresponding classification into a driver height class may be considered. This has effects in the case of very short drivers in particular, in which the prevailing lever ratios are different from those of tall drivers and, for example, pressing down all the way on the brake pedal requires greater effort than in the case of tall drivers.

The driver type identification is advantageously performed automatically with the help of sensors in the vehicle. For example, this takes place via different sensors immediately after starting the vehicle. For example, it is possible to ascertain the driver's weight by a weight ascertaining device integrated into the driver's seat or to ascertain the current seat position via a seat position ascertaining device. If these two variables, i.e., the driver's weight and the seat position, are considered together, the differentiation between a man and a woman may be made with a certain probability. For example, if the weight is relatively low and if the driver's seat has been pushed toward the front, approaching the steering wheel, it is possible to deduce with high probability that the driver is a woman, whereas if the weight is high and the seat position has been pushed back, there is high probability that the driver is a man. If necessary, the driver's position in the front or rear seat surface area is also used as a criterion.

For example, a capacitive sensor with which the water content in the body is ascertainable may be used as the age ascertaining device for automatically ascertaining the age category. This is based on the idea that the water content percentage in the body changes with age. A capacitive sensor whose signal depends on the pressure load makes it possible to ascertain to what extent the driver's body tissue changes under pressure, which may be used as a measure of age. An alternative method for ascertaining age provides for the use of an ultrasonic sensor with which the bone density and/or bone marrow structure may be determined and then also used to estimate the driver's age.

Regardless of the automatic driver type identification via a sensor system to be included in the vehicle, it is also possible to manually activate and/or adjust the driver type identification. For example, parameters describing the driver type may be stored in a regulating and control unit in the vehicle and may be activated directly by the driver. It is also possible to automatically activate such stored information about the current driver on the basis of typical features, including typical driver responses.

In addition to the classification into discrete driver type classes having a set of defined brake system characteristic variables assigned to each class, continuous reparameterization of these characteristic variables may also be performed. To do so, typical driver responses may be measured, e.g., steering wheel operation or operation of the accelerator pedal and/or the brake pedal and limiting values may be defined in the brake assistant according to a functional correlation. An approach to continuous reparameterization is also possible through a reduction in the size of the discrete steps, i.e., including a plurality of driver type classes. In all cases, the reparameterization in the brake system is advantageously performed before the onset of a hazardous situation.

Additional advantages and expedient embodiments are described in the additional claims, the description of the figures and the drawings.

### BRIEF DESCRIPTION OF THE DRAWINGS

FIG. 1 shows a perspective view of a vehicle having a regulating and control unit arranged therein, generating adjusting signals for acting upon the brake system as well as various additional secondary units in the vehicle.

FIG. 2 shows a flow chart for performing the parameter change in the brake system in order to achieve the best possible shortening of stopping distance, depending on the driver type.

### DETAILED DESCRIPTION

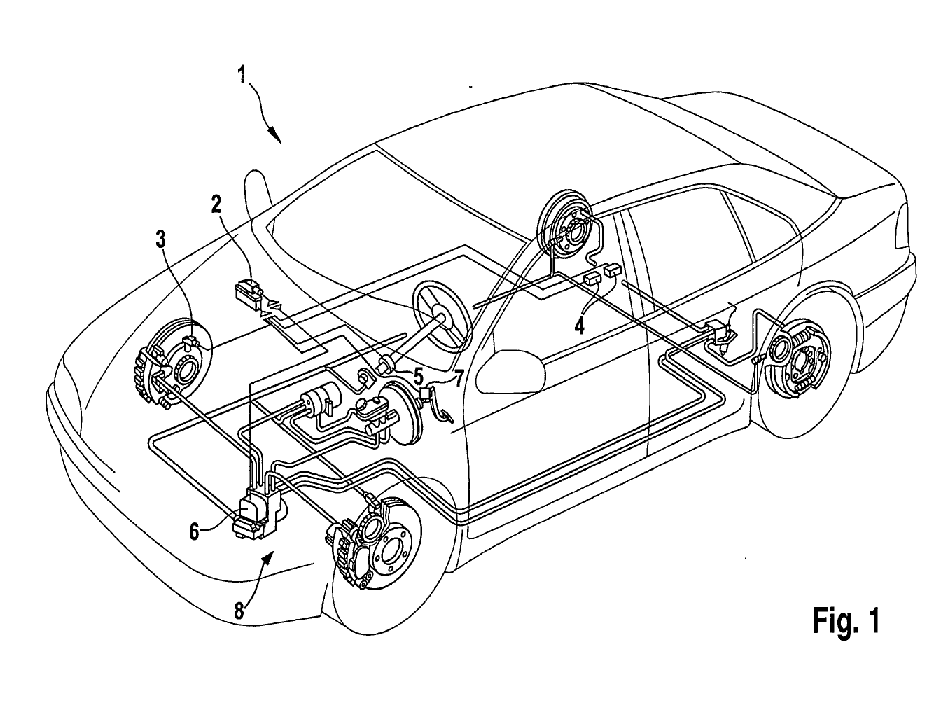

FIG. 1 shows a motor vehicle 1 having a regulating and control unit 2, which is connected to various sensors 3, 4, 5 and 7 by which the regulating and control unit receives sensor signals that transmit current vehicle state variables and operating variables of the motor vehicle. From the supplied sensor signals, regulating and control unit 2 generates adjustment signals which are sent to the internal combustion engine and/or the various secondary units in the vehicle to influence the vehicle state. FIG. 1 shows a hydraulic unit 6 as part of a brake system 8 that is influenceable by the adjusting signals of the regulating and control unit. In this way, a brake assistant may be implemented, including functionally the components of automotive brakes as part of the brake system, hydraulic unit 6 and regulating and control unit 2. The brake assistant detects emergency situations and supports a braking operation initiated by the driver by increasing the brake pressure.

The sensor system in vehicle 1 includes a wheel rotational speed sensor 3 on one or more vehicle wheels, a yaw rate and/or acceleration sensor 4 for ascertaining current accelerations and/or the yaw rate, a steering wheel angle sensor 5 for ascertaining the current steering wheel angle, and a brake pedal sensor for ascertaining the current brake pedal operation, in particular the pedal speed and the pressure exerted on the brake pedal by the driver. In addition, the sensor system advantageously includes a weight ascertaining device, which is integrated into the driver's seat to ascertain the driver's weight as well as a seat position ascertaining device, which is also integrated into the driver's seat to be able to ascertain the driver's current seat position. The weight ascertaining device is designed as load bolts or as a so-called OC mat (occupant classification mat). If necessary, the seat position may be ascertained via such a mat to determine whether the driver is sitting in the area of the front or rear seat surface. Furthermore, the position of the driver's seat in the vehicle is ascertained and there is a determination of whether the driver's seat is in a forward position approaching the steering wheel or is pushed into a back position. In addition, camera techniques may also be used to detect the height and/or position of the driver and also the passenger, if necessary. Finally, the sensor system may also include a capacitive sensor, which is likewise integrated into the driver's seat in particular and generates, in response to pressure, sensor signals which map the tension in body tissue, from which the driver's age may be estimated. Such an age ascertaining device may alternatively or additionally be provided in the form of an ultrasonic sensor with the help of which the bone density and/or bone marrow structure may be ascertained and then used to estimate the driver's age.

With the help of the sensors present in motor vehicle 1, driver type identification may be performed automatically. The sensor signals first ascertain responses typical of the driver, e.g., during operation of the steering wheel or the brake pedal, and also ascertain driver type-specific properties which are independent of driver response, such as the current seat position in the front or rear area of the seat surface, the driver's weight, the driver's height and the estimated age of the driver. With the help of this information, the driver may then be assigned to a driver type class, and there are advantageously at least two driver type classes for different age classes, at least two driver type classes for different driver heights, two driver type classes for the male/female differentiation, and at least two driver type classes for different age groups. The signals from the sensors in the vehicle allow an assignment of the current driver to each of the aforementioned driver type classes. Since a set of defined brake system parameters is assigned to each driver type class, a driver-individual adaptation of the brake system may be performed before a hazardous and/or emergency situation occurs. In the event of a hazard, a rapid buildup of pressure in the brake system is thus possible as a function of the brake assistant, which results in shortening of the stopping distance.

On the whole, this yields a multidimensional discrete driver type class system in which each driver is classified in multiple classes. For example, a male driver is classified as “male” in the driver type class for gender; in the driver type class for age, the driver is classified in the category “young driver,” “middle-aged driver,” or “elderly driver,” depending on his/her age; in addition, a classification as a person of low or high weight is also possible. Combining these discrete assignments to the particular driver type classes yields individually adapted sets of brake system parameters.

The assignment to the various driver type classes may be made directly in part, e.g., by ascertaining the weight, the driver may be classified as having a high or low weight, but to some extent the assignment may be made only through probabilities and/or plausibilities. Thus the differentiation of gender may be made with a certain probability based on the sensor signals for the driver's weight and the seat position of the driver and/or the position of the driver's seat. In the case of a person of a relatively low weight, assuming a seat position in the area of the front seat surface or for whom the driver's seat is pushed forward, there is an increased probability that the driver is a woman. However, if the seat position is in the area of the rear seat surface of the driver's seat or if the driver's seat is pushed toward the back and if the weight is relatively high, there is an increased probability that the driver is a man.

Additionally or alternatively to automatic driver type detection, this may also be set and/or supported manually. For example, person-specific data may be stored in the regulating and control unit and are then activated by the corresponding driver. Furthermore, it is possible to automatically perform the activation of these person-based data via the sensor signals.

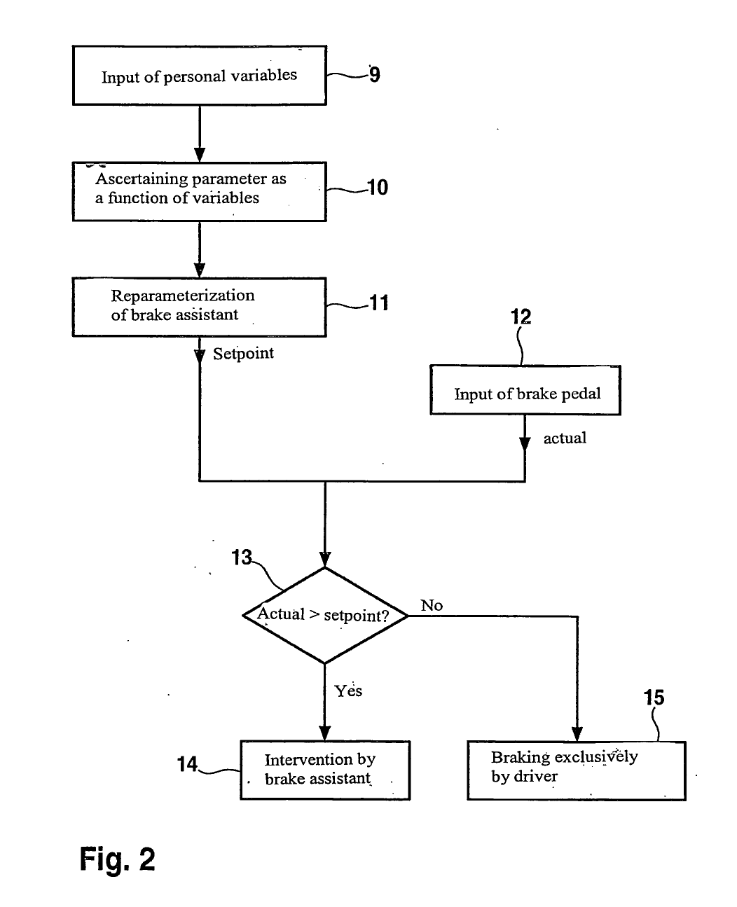

As the flow chart according to FIG. 2 shows, first a driver type identification is performed in method steps 9, 10 and 11 and accordingly a set of predefined parameters of the brake system is activated. According to method step 9, person-specific variables are entered and are ascertained in particular with the help of the sensor system in the vehicle, optionally also for manual activation by the driver. In method step 10, after driver type identification and assignment to the corresponding driver type classes have been performed, the brake system parameters are defined. Since an assignment to a plurality of different driver type classes is usually made, e.g., for gender, weight, height and age, entries are added to and/or subtracted from the individual parameter variables, depending on the assignment, starting from an initial parameter set. In method step 11, the brake assistant is then reparameterized using the newly ascertained characteristic variables, representing setpoint variables, in particular threshold values, which must be exceeded to deploy, i.e., activate, the brake assistant. The setpoint variables are then used as the basis for an inquiry in method step 13.

As depicted in method step 12, brake pedal activation is sensed by the brake pedal sensor. Actual values representing operation of the brake pedal by the driver, e.g., the pedal speed and the pedal pressure, are recorded as actual values. These actual values plus the setpoint values from method step 11 are then sent to following method step 13, where a comparison is performed between the actual values and the setpoint values and a check is performed to ascertain whether the prerequisites for activation of the brake assistant are met, which is the case when pedal operation exceeds the driver-individual limiting values. In this case, the system continues to method step 14 according to the yes branch, and the braking operation is performed with support by the brake assistant to fully utilize the maximum brake potential and achieve the best possible shortening of the stopping distance.

However, if pedal operation is below the assigned threshold values, the prerequisites for activation of the brake assistant are not met. In this case, following the no branch, the flow chart branches off to method step 15 and braking takes place exclusively via pedal operation by the driver without support from the brake assistant.

What is claimed is:

1-14. (canceled)

15. A method for setting characteristic variables of a brake system in a motor vehicle, the method comprising:
performing a driver type identification and classifying the identified type of driver into at least one or assigned driver type classes; and
activating the brake system characteristic variables of these driver type classes;
wherein a set of defined brake system characteristic variables is assigned to each class of the different driver type classes.

16. The method of claim 15, wherein two driver type classes are provided for different genders.

17. The method of claim 15, wherein at least two driver type classes are provided for different age classes.

18. The method of claim 15, wherein at least two driver type classes are provided for different driver heights.

19. The method of claim 15, wherein the driver type identification is performed automatically with the help of sensors.

20. The method of claim 19, wherein the weight of the driver is ascertained via a weight ascertaining device integrated into the driver's seat.

21. The method of claim 19, wherein the current position of the driver's seat is ascertained via a seat position ascertaining device.

22. The method of claim 20, wherein the driver type “woman” is identified via an analytical logic unit if the weight is low and the driver's seat is in a forward position approaching the steering wheel, and the driver type “man” is identified if the weight is higher and the driver's seat is pushed back.

23. The method of claim 19, wherein the age of the driver is estimated via an age ascertaining device, for example, a capacitive sensor for ascertaining the water content in the body or an ultrasonic sensor for ascertaining the bone density and/or the bone marrow structure.

24. The method of claim 15, wherein the driver type identification is at least one of set manually and activated manually.

25. The method of claim 15, wherein at least one brake system characteristic variable of a brake assistant system is set.

26. The method of claim 25, wherein the characteristic variable of the brake assistant system is the pedal speed.

27. The method of claim 25, wherein the characteristic variable of the brake assistant system is the pedal pressure.

28. A control unit for setting characteristic variables of a brake system in a motor vehicle, comprising:
a first arrangement to perform a driver type identification and classify the identified type of driver into at least one assigned driver type class; and
a second arrangement to activate the brake system characteristic variables of these driver type classes;
wherein a set of defined brake system characteristic variables is assigned to each class of the different driver type classes.
